(19) United States
(12) Patent Application Publication
(10) Pub. No.: US 2023/0024106 A1
(43) Pub. Date: Jan. 26, 2023

(54) INFANT LARRY BRACKET

(71) Applicant: Hubei Zeblaze Smart Company Limited, Xiang Yang (CN)

(72) Inventor: Tao Bu, Xiang Yang (CN)

(21) Appl. No.: 17/384,129

(22) Filed: Jul. 23, 2021

(51) Int. Cl. A47D 9/04

(52) U.S. Cl. CPC A47D 9/04

(57) ABSTRACT

The invention discloses a bracket. The new-type infant larry bracket comprises two placing frames. The two frames are movably arranged on the right base and the left base respectively. The right base and the left base have a connecting section. The right base and the left base can be disassembled and fixed at both ends of the connecting bridge section. The two placing frames can slide forward and backward on the right base and the left base respectively. The utility model has a reasonable structure, which can help a baby to sleep smoothly and autonomously and does not need parents to accompany for a long time.

### TECHNICAL FIELD

The utility model relates to the field of an infant larry, in particular to a bracket used for an infant larry.

### BACKGROUND TECHNOLOGY

An infant refers to a child less than one year old, weighing about 9 kg-10 kg. At this stage, infant growth and development is particularly rapid, and it is the most vigorous stage in a person's life. However, at this stage, infants need reliable care most. Infants at this stage can't stand on their own and can only take a lying position. Usually, parents will hold the baby or use a crib. With the development of society, most families will also use infant larries (trolleys) for babies to rest.

Infants need a lot of time to sleep to ensure their growth. Therefore, how to ensure their babies to sleep peacefully is a problem for parents. Usually, parents will use a gentle wave to inhibit the infant's brain activity and sense of fear, so that the baby will no longer cry and germinate drowsiness. However, in this way, it is time-consuming and laborious for a specially assigned person to push the larry or directly hold the baby. Parents can't handle other affairs at this stage. Ordinary families obviously can't afford the high price of an electric cradle. Furthermore, an electric cradle can only be fixed and can't be carried when the baby needs to go out. Therefore, how to ensure the smooth sleep of the baby, without the need for parents to keep watch and be able to have time to deal with other things has been a problem.

### Contents of the Utility Model

The utility model is a kind of infant larry bracket aiming to solve the shortcomings existing in the prior art.

In order to achieve the above purpose, the utility model adopts the following technical scheme:

The kind of infant larry bracket comprises two placing frames. The two placing frames are respectively movably arranged on the right base and the left base. A bridge section is arranged between the right base and the left base. The right base and the left base are respectively detachable and fixedly arranged at the two ends of the bridge section, and the two placing frames can respectively slide forward and backward on the right base and the left base.

The connecting bridge section is inserted on the right base and the left base through the inserting tube. The upper cover and the lower cover are respectively located at the upper and lower ends of the inserting tube. The upper cover and the lower cover are pressed and fixed to form a whole. The upper cover and the lower cover form a cavity. The connecting bridge section passes through the two ends of the cavity, and the end face of the upper cover is provided with a window connected with the cavity. And the inner cavity of the upper cover is located on both sides of the window, and an inserting seat is symmetrically arranged.

The inserting tube comprises a large aluminum tube, a small aluminum tube and a fixing piece. The fixing piece is inserted and fixed at the end of the large aluminum tube. The small aluminum tube extends into the large aluminum tube through the fixing piece. The small aluminum tube is provided with a screw hole. The tube wall of the large aluminum tube is provided with a waist shaped hole, and the fixing piece is provided with a waist shaped notch. The structure and size of the waist shaped notch match the waist shaped hole, and the screw thread is connected in the screw hole. The screw is matched with the waist hole and the waist notch.

The right seat groove for fixing the slide rail seat is symmetrically arranged on both sides of the upper end of the seat body of the right base, and the left seat groove for fixing the slide rail seat is symmetrically arranged on both sides of the upper end of the seat body of the left base. Both sides of the lower end of the two placing frames are fixedly connected with the sliding parts of the slide rail. Through the cooperation of the sliding parts of the slide rail and the slide rail base, the two placing frames can slide back and forth on the right base and the left base respectively.

The lower end of the right base is provided with a right socket for inserting the end of the small aluminum tube. The right socket is provided with a threaded hole. After the end of the small aluminum tube is inserted into the right socket, it is fixed by bolts. The lower end of the left base is provided with a left socket for inserting the end of the large aluminum tube. The left socket is provided with a threaded hole. After the upper cover and the lower cover are pressed and fixed as a whole, the two ends of the right socket respectively form a sheath covering the small aluminum tube and the large aluminum tube. The end of the sheathed large aluminum tube is inserted into the left socket and fixed by bolts. The placing frame includes a sliding sleeve and two frame body connecting blocks on the upper end face of the sliding sleeve. The two frame body connecting blocks are relatively arranged at the front and rear ends of the sliding sleeve. The outer side of the sliding sleeve is located between the two frame body connecting blocks and has a limit strip. The sliding sleeve and the sliding part of the sliding rail are fixedly connected by bolts. The upper end of the inner wall of the sliding sleeve is also provided with a magnetic steel mounting frame. The upper end face of the right base is provided with a first coil winding assembly cavity matched with the larry placing frame, and the upper end face of the left base is provided with a second coil winding assembly cavity matched with the placing frame.

The lower ends of the seat bodies of the right base and the left base are fixedly provided with anti-skid pads.

Compared with the prior art, the utility model has the beneficial effect: the larry bracket disclosed in the application is small in volume, which can be easily carried when the baby needs to go out, and the position can be changed at will when it is used at home without any inconvenience.

Furthermore, the larry bracket of the application can be used with infant larries. Only two front wheels of the infant larry need to be respectively placed on the corresponding placing frame. Because the two placing frames can respectively slide back and forth on the right base and the left base, and the larry also has two rear wheels that can roll, in this way, the infant larry can be pushed and pulled when the placing frame is moving back and forth. At this time, the larry is similar to a cradle swinging. In this way, the baby can go to sleep smoothly without the need of parents' long-term care, which liberates the parents' hands.

### DESCRIPTION OF FIGURES

FIG. 1 is a three-dimensional structure diagram of the utility model;

FIG. 2 is a three-dimensional structure diagram of the utility model;

FIG. 3 is a schematic diagram of the structural relationship between the right base 2 and the larry placing frame 1 of the utility model;

FIG. 4 is the structural diagram of the right base 2 of the utility model;

FIG. 5 is a schematic diagram of the structural relationship between the left base 3 and the larry placing frame 1 of the utility model;

FIG. 6 is the structural diagram of the left base 3 of the utility model;

FIG. 7 is a schematic diagram of the structural relationship between the large aluminum tube 403, the small aluminum tube 404 and the fixing part 405 of the utility model;

FIG. 8 is the structural diagram of the small aluminum tube 404 of the utility model;

FIG. 9 is the structural schematic diagram of the fixator 405 of the utility model;

FIG. 10 is the structural diagram of the slide rail slide part 6 of the utility model;

FIG. 11 is the structural diagram of the slide rail seat 5 of the utility model;

FIG. 12 is the structural diagram of the upper cover 401 of the utility model;

FIG. 13 is the structural diagram of the sliding sleeve 101 of the utility model.

In the figure: 1 larry placing frame, 101 sliding sleeve, 1011 magnetic steel mounting frame, 102 frame body connecting block, 103 limit bar, 2 right base, 201 right base groove, 202 right socket, 203 first coil winding assembly cavity, 3 left base, 301 left base groove, 302 left socket, 303 second coil winding assembly cavity, 4 connecting bridge section, 401 upper cover, 4011 window, 4012 plug-in seat, 402 lower cover, 403 large aluminum tube 4031 waist hole, 404 small aluminum tube, 4041 screw hole, 405 fastener, 4051 waist notch, 406 screw, 407 sheath, 5 slide rail seat, 6 slide rail sliding part, 7 anti-skid pad.

### Concrete Manifestation

The technical solutions in the embodiments of the utility model will be described clearly and completely in combination with the drawings in the embodiments of the utility model. Obviously, the described embodiments are only part of the embodiments of the utility model, not all of them.

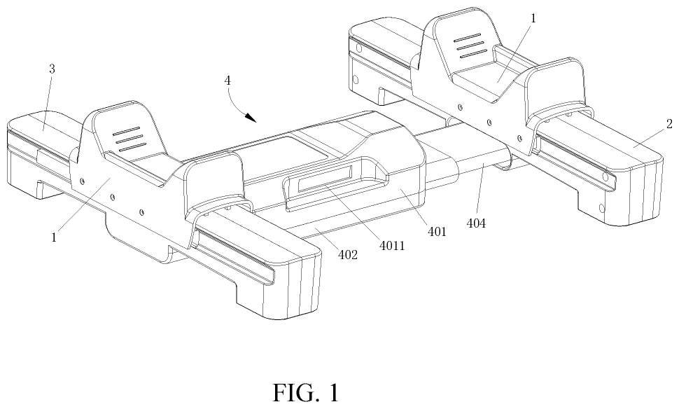

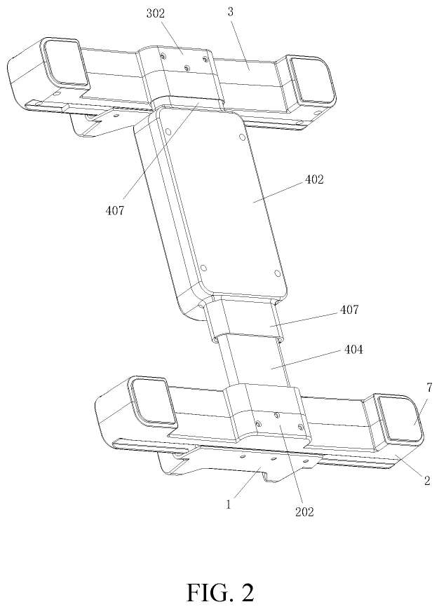

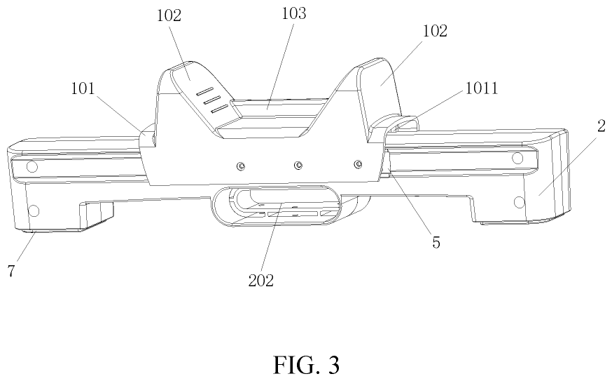

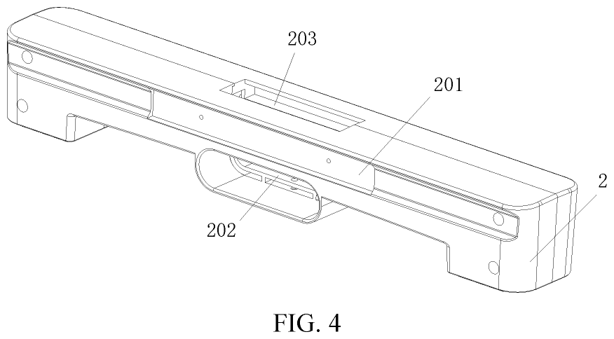

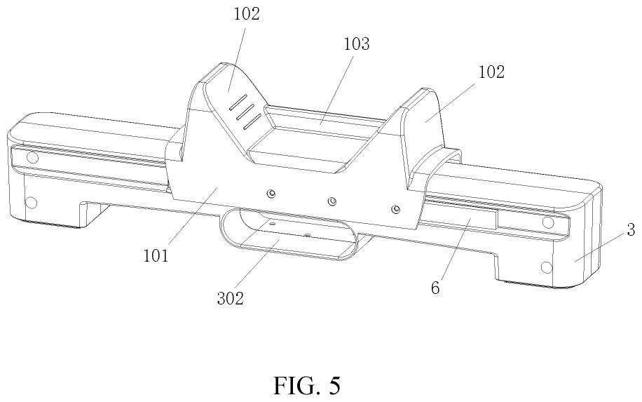

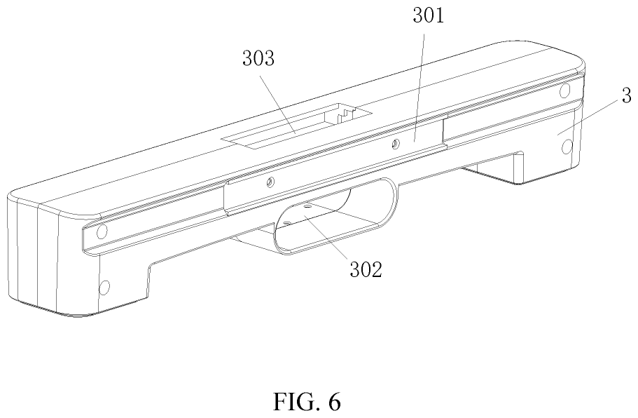

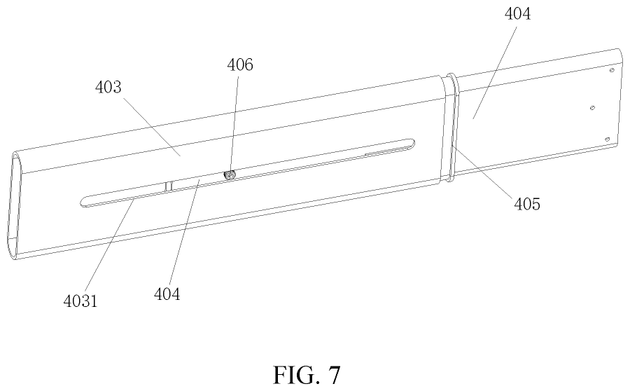

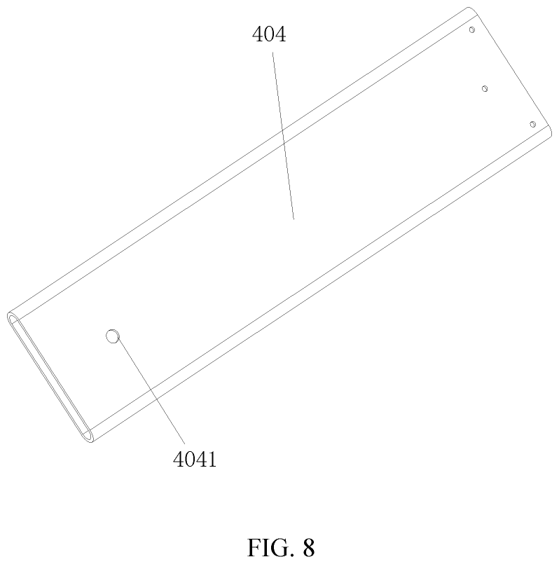

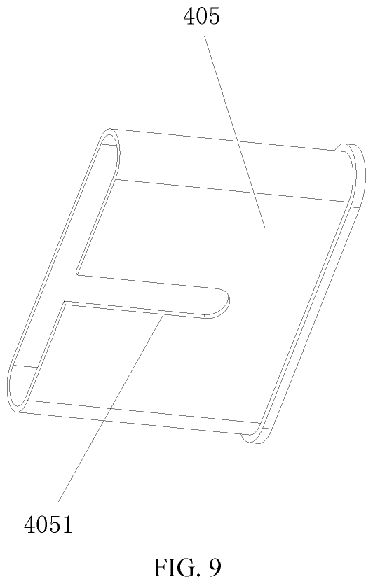

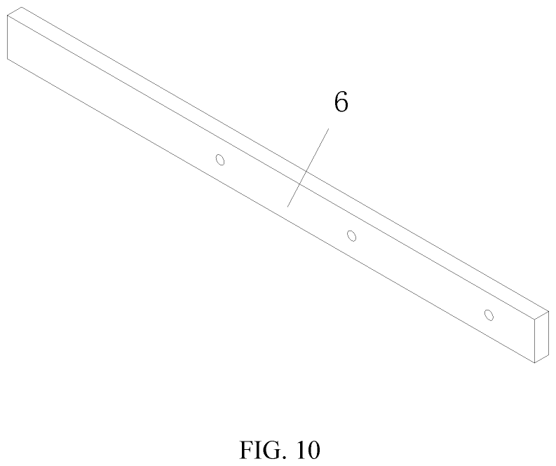

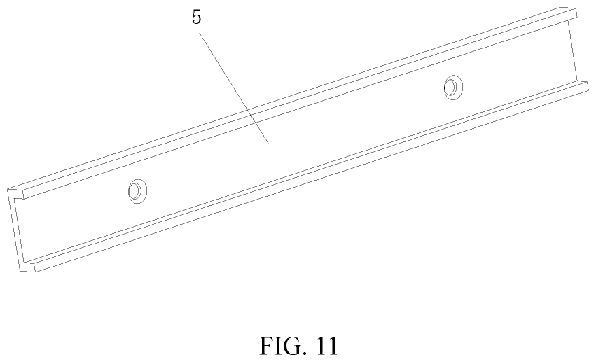

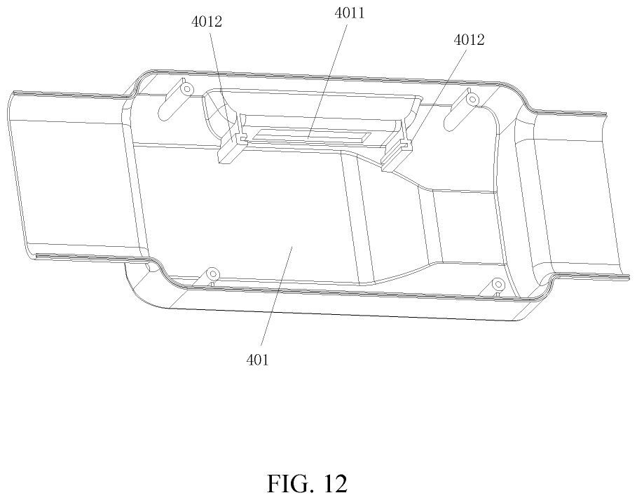

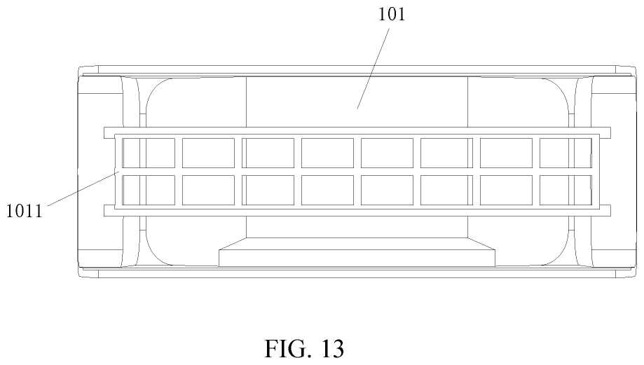

Referring to FIG. 1-13, an infant larry bracket comprises two rocking carriage placing frames 1, which are respectively movably arranged on the right base 2 and the left base 3. A bridge section 4 is arranged between the right base 2 and the left base 3, and the right base 2 and the left base 3 are respectively detachable and fixedly arranged at both ends of the bridge section 4. The two larry placing frames 1 can slide forward and backward on the right base 2 and the left base 3 respectively.

The bridge connecting section 4 comprises an inserting pipe, an upper cover 401 and a lower cover 402. The bridge connecting section 4 is inserted on the right base 2 and the left base 3 through the inserting pipe. The upper cover 401 and the lower cover 402 are respectively located at the upper and lower ends of the inserting pipe. The upper cover 401 and the lower cover 402 are pressed and fixed to form a whole body. A cavity is formed between the upper cover 401 and the lower cover 402. The bridge connecting section 4 passes through both ends of the cavity. The end face of the upper cover 401 is provided with a window 4011 communicated with the cavity, and the inner cavity of the upper cover 401 is located on both sides of the window 4011, and an inserting seat 4012 is symmetrically arranged. The upper cover 401 and the lower cover 402 can be pressed and fixed by screws, and the master control circuit can be placed into the cavity formed between the upper cover 401 and the lower cover 402, and the display of the master control circuit can just expose from the window 4011 to facilitate user to observe the parameters.

The inserting pipe comprises a large aluminum tube 403, a small aluminum tube 404 and a fixing part 405, the fixing part 405 is inserted and fixed on the end part of the large aluminum tube 403, the small aluminum tube 404 extends into the large aluminum tube 403 through the fixing part 405, the small aluminum tube 404 is provided with a screw hole 4041, the tube wall of the large aluminum tube 403 is provided with a waist shaped hole 4031, the fixing part 405 is provided with a waist shaped notch 4051, the structure and size of the waist shaped notch 4051 are matched with the waist shaped hole 4031, the screw 406 is threaded into the screw hole 4041, and the screw 406 is matched with the waist shaped hole 4031 and waist shaped notch 4051. Such a kind of structure can ensure adjustability of relative position of the large aluminum tube 403 and the small aluminum tube 404, so the distance between the right base 2 and the left base 3 can be adjusted, so as to ensure reliable placing of the two front wheels of various infant larries.

The right seat groove 201 for fixing the slide rail seat 5 is symmetrically arranged on both sides of the upper end of the seat body of the right base 2, and the left seat groove 301 for fixing the slide rail seat 5 is symmetrically arranged on both sides of the upper end of the seat body of the left base 3. Both sides of the lower end of the two mounting frames 1 are fixedly connected with the slide rail slide piece 6, and the slide rail slide piece 6 is matched with the slide rail seat 5. The two mounting frames 1 slide forward and backward on the right base 2 and the left base 3 respectively. The slide rail seat 5 can be fixed in the right seat groove 201 and the left seat groove 301 by screws. The slide rail slide piece 6 can be fixed on both sides of the lower end of the mounting frame 1 by screws, and the slide rail slide piece 6 and the slide rail seat 5 adopt silent slide rail components.

The lower end of the right base 2 is provided with a right socket 202 for inserting the end of the small aluminum tube 404. The right socket 202 is provided with a threaded hole. After the end of the small aluminum tube 404 is inserted into the right socket 202, it is fixed by bolts. The lower end of the left base 3 is provided with a left socket 302 for inserting the end of the large aluminum tube 403. The left socket 302 is provided with a threaded hole. The two ends of the utility model respectively form a sheath 407 covering the small aluminum tube 404 and the large aluminum tube 403. The sheath 407 covers the end of the large aluminum tube 403, which is inserted into the left socket 302 and fixed by bolts. The larry placing frame 1 comprises a sliding sleeve 101 and two body connecting blocks 102 on the upper end face of the sliding sleeve 101, and the two body connecting blocks 102 are relatively arranged at the front and rear ends of the sliding sleeve 101. The outer side of the sliding sleeve 101 is located between the two connecting blocks 102 of the frame body and is provided with a limiting strip 103. The sliding sleeve 101 is fixedly connected with the sliding part 6 of the sliding rail by bolts. The upper end of the inner wall of the sliding sleeve 101 is also provided with a magnetic steel placing frame 1011. The upper end face of the right base 2 is provided with a first coil winding assembly cavity 203 matched with the larry placing frame 1. The upper end surface of the left base 3 is provided with a second coil winding assembly cavity 303 which is matched with the larry placing frame 1. During processing, the manufacturing enterprise can install the magnetic steel in the sliding sleeve 101, and the magnetic steel can be fixed through the magnetic steel mounting frame 1011. The magnetic steel sheet with coil winding can be fixed in the first coil winding assembly cavity 203 of the right base 2, and the magnetic steel sheet with coil winding can also be fixed in the second coil winding assembly cavity 303 of the left base 3. Using the principle of linear motor, the two larry mounting frames 1 can be driven to slide back and forth on the right base 2 and the left base 3 respectively. The control circuit installed between the upper cover 401 and the lower cover 402 can control the front and back sliding action of the two larry mounting frames 1, and then push and pull the baby cradle through the larry mounting frame 1. Just place the two rollers at the front end of the baby rocking cart on the two larry placing frames 1, and then the rollers can be fixed between the two frame connecting blocks 102, and the limit strip 103 can play the purpose of auxiliary limit.

The lower end of the seat body of the right base 2 and the left base 3 is fixedly provided with an anti-skid pad 7.

It should be noted that the standard parts used by the utility model can be purchased from the market. The special-shaped parts can be customized according to the description and the attached drawings. The specific connection mode of each part adopts the conventional means such as bolts, rivets and welding in the existing technology, and the machinery, parts and equipment adopt the conventional models in the existing technology. The inventor will not elaborate here.

The above is only the better specific implementation mode of the utility model, but the protection scope of the utility model is not limited to this. Any technical personnel familiar with the technical field will replace or change the technical scheme of the utility model and the concept of the utility model within the technical scope disclosed by the utility model. All of them shall be covered in the protection scope of the utility model.

1. An infant larry bracket, comprises two placing frames (1), the two frames (1) are respectively movably arranged on a right base (2) and a left base (3), a bridge section (4) is arranged between the right base (2) and the left base (3), the right base (2) and the left base (3) can be removed and fixed at both ends of the connecting bridge section (4), the two placing frames (1) can slide forward and backward on the right base (2) and the left base (3) respectively.

2. The infant larry bracket according to claim 1, wherein, the bridge connecting section (4) comprises an inserting tube, an upper cover (401) and a lower cover (402), the bridge connecting section (4) is inserted on the right base (2) and the left base (3) through the inserting tube, the upper cover (401) and the lower cover (402) are respectively located at the upper and lower ends of the inserting tube, the upper cover (401) and the lower cover (402) are pressed and fixed to form a whole, and a cavity is formed between the upper cover (401) and the lower cover (402), the inner cavity of the upper cover (401) is located on both sides of the window (4011), and an inserting seat (4012) is symmetrically arranged.

3. The infant larry bracket according to claim 2, wherein. the inserting tube comprises a large aluminum tube (403), a small aluminum tube (404) and a fixing part (405), the fixing part (405) is inserted and fixed at the end of the large aluminum tube (403), and the small aluminum tube (404) extends into the large aluminum tube (403) through the fixing part (405), the small aluminum tube (404) is provided with a screw hole (4041), the tube wall of the large aluminum tube (403) is provided with a waist shaped hole (4031), and the fixing part (405) is provided with a waist shaped notch (4051), the structure and size of the waist notch (4051) are matched with the waist hole (4031), the screw (406) is threaded in the screw hole (4041), and the screw (406) is matched with the waist hole (4031) and the waist notch (4051).

4. The infant larry bracket according to claim 1, wherein, the both sides of the upper end of the seat body of the right base (2) are symmetrically provided with a right seat groove (201) for fixing the slide rail seat (5); a left seat groove (301) for fixing the slide rail seat (5) is symmetrically arranged on both sides of the upper end of the seat body of the left base (3); both sides of the lower end of the two placing frames (1) are fixedly connected with the slide rail slide (6); through the cooperation of the slide rail slide piece (6) and the slide rail base (5), the two placing frames (1) realize the front and rear sliding on the right base (2) and the left base (3) respectively.

5. The infant larry bracket according to one of claim 1, wherein the lower end of the right base (2) is provided with a right socket (202) for inserting the end of the small aluminum tube (404); the right socket (202) is provided with a threaded hole; after the end of the small aluminum tube (404) is inserted into the right socket (202), it is fixed by bolts; the lower end of the left base (3) is provided with a left socket (302) for inserting the end of the large aluminum tube (403); the left socket (302) is provided with a threaded hole; after the upper cover (401) and the lower cover (402) are pressed and fixed as a whole, the two ends of the upper cover (401) respectively form a sheath (407) covering the small aluminum tube (404) and the large aluminum tube (403); the end of the large aluminum tube (403) wrapped by the sheath (407) is inserted into the left socket (302) and fixed by bolt; wherein the placing frames (1) comprise a sliding sleeve (101) and two frame body connecting blocks (102) on the upper end face of the sliding sleeve (101), and the two frame body connecting blocks (102) are relatively arranged at the front and rear ends of the sliding sleeve (101); the outer side of the sliding sleeve (101) is located between the two connecting blocks (102) of the frame body, and is provided with a limiting strip (103); the sliding sleeve (101) is fixedly connected with the sliding part (6) of the sliding rail by bolts; the upper end of the inner wall of the sliding sleeve (101) is also provided with a magnetic steel mounting frame (1011); the upper end face of the right base (2) is provided with a first coil winding assembly cavity (203) which is matched with the placing frames (1); the upper end surface of the left base (3) is provided with a second coil winding assembly cavity (303) which is matched with the placing frames (1).

6. The larry bracket according to one of claim 1, wherein the lower ends of the seat bodies of the right base (2) and the left base (3) are fixedly provided with anti-skid pads (7).
